(19) United States
(12) Patent Application Publication
(10) Pub. No.: US 2016/0070161 A1
(43) Pub. Date: Mar. 10, 2016

(54) Illuminated 3D Model

(71) Applicants: Matthew Fetterman, Waltham, MA (US); Robert Allen Freking, Billerica, MA (US); Zachary James Weber, Cambridge, MA (US)

(72) Inventors: Matthew Fetterman, Waltham, MA (US); Robert Allen Freking, Billerica, MA (US); Zachary James Weber, Cambridge, MA (US)

(73) Assignee: Massachusetts Institute of Technology, Cambridge, MA (US)

(21) Appl. No.: 14/843,947

(22) Filed: Sep. 2, 2015

Related U.S. Application Data
(60) Provisional application No. 62/045,693, filed on Sep. 4, 2014.

(51) Int. Cl. G03B 21/606; H04N 9/31; G03B 21/62

(52) U.S. Cl. CPC G03B 21/606; G03B 21/62; H04N 9/3155; B33Y 10/00

(57) ABSTRACT

An illuminated three-dimensional model is fabricated by importing or generating a digital dataset representing the surface of a three-dimensional source surface; producing a three-dimensional model of the three-dimensional source surface from the digital dataset, wherein the three-dimensional model has a translucent or diffusive surface and a base surface; and mounting a projection device in a configuration such that distinctive patterns of light are directed from the projection device through the base surface of the three-dimensional model to selectively illuminate at least a portion of the translucent or diffusive surface of the three-dimensional model.

### RELATED APPLICATION

This application claims the benefit of U.S. Provisional Application No. 62/045,693, filed 4 Sep. 2014, the entire content of which is incorporated herein by reference.

### GOVERNMENT SUPPORT

This invention was made with government support under Contract No. FA8721-05-C-0002 awarded by the U.S. Air Force. The government has certain rights in the invention.

### BACKGROUND

Fascination with three-dimensional (3D) models of cities predates the first human aerial ascent by centuries. The advantages of volumetric, bird's-eye perspectives were readily appreciated by French military strategists as long ago as the turn of the 18th century and were later appreciated by others as works of art. Today, cityscapes of monumental extent capture the limelight. For example, the 1:1200 scale Panorama of the City of the New York, commissioned for the 1964 World's Fair and now at the Queens Museum, comprises 830,000 buildings, with a model size exceeding 1000 m².

Although static models have predominated, active lighting has recently been incorporated in 3D city models. The city model of the London Building Centre, developed for the 2012 Olympics, employs changing overhead spot lighting; and the future city model of the Shanghai Urban Planning Exhibition Center utilizes individual light emitting diodes (LEDs) embedded within the scale buildings. Beyond the advertisement value, these miniature cities can be used in a variety of applications, such as urban planning, homeland security, military strategizing, disaster relief, and artistic display.

Recently, modelers have begun leveraging 3D printing to generate individual model buildings. In particular, a team of artists modeled 1,000 downtown Chicago buildings to recreate a faithful model of the city.

### SUMMARY

Illuminated three-dimensional models and methods for fabricating and using the models are described herein, where various embodiments of the apparatus and methods may include some or all of the elements, features and steps described below.

An illuminated three-dimensional model can be fabricated by importing or generating a digital dataset representing the surface of a three-dimensional source surface. A three-dimensional model of the three-dimensional source surface can then be generated from the digital dataset, wherein the three-dimensional model has a translucent or diffusive surface (e.g., as a consequence of a coating or surface profiling) and a base surface. A projection device can then be mounted in a configuration such that distinctive patterns of light are directed from the projection device through the base surface of the three-dimensional model to selectively illuminate at least a portion of the translucent or diffusive surface of the three-dimensional model.

The three-dimensional model can be produced by 3D printing and can be printed as a plurality of tiles. The plurality of tiles can be joined after printing.

The three-dimensional model can also be formed by fabricating a positive or negative reproduction of the three-dimensional source surface by 3D printing, which is then cast through as many positive and negative stages as necessary to produce a positive reproduction of the model in an optically translucent material.

The positive reproduction can be printed as a plurality of tiles, wherein additional stages of intermediate casting can be employed to join the tiles.

In a particular embodiment, the 3D-printed positive reproduction can comprise acrylonitrile butadiene styrene; the negative mold can comprise silicone; and the cast positive three-dimensional model can comprise a urethane polymer.

The three-dimensional model can be substantially transparent under the translucent/diffusive surface. Moreover, the translucent/diffusive surface of the three-dimensional model can be modified by coating the three-dimensional model with a diffusive coating.

Embodiments of the illuminable three-dimensional model apparatus can include the following components: (1) a three-dimensional model of a three-dimensional source surface that has a base surface and a translucent/diffusive surface and (2) a projector mounted beneath the three-dimensional source surface and configured to direct light images through the base surface of the three-dimensional model and selectively illuminate at least a portion of the translucent/diffusive surface of the three-dimensional model.

The illuminable three-dimensional model apparatus can further include one or more optical elements mounted in the display enclosure and configured to direct light images from the projector onto the base surface of the three-dimensional model.

A method for selective illumination of a three-dimensional model can include the following: utilizing an illuminable three-dimensional model apparatus, comprising a display enclosure; a three-dimensional model of a three-dimensional construct, wherein the three-dimensional source surface is mounted atop the display enclosure, wherein the three-dimensional model includes a translucent/diffusive surface; and a projector mounted inside the display enclosure. A light image with distinct visual features (e.g., text, static images, or moving images) can be directed from the projector through the three-dimensional model to differentially illuminate portions of the translucent/diffusive surface.

In one embodiment, the light image can be directed from the projector onto one or more mirrors that reflects the light image onto the three-dimensional model; and the three-dimensional model can be a model of at least a portion of a city. The light image from the projector can selectively illuminate individual buildings, parts of buildings or other elements in the city. In particular embodiments, the light image can include a representation of a satellite image. In additional embodiments, the composition of the light image can change over time to provide dynamic illumination of the three-dimensional model.

### BRIEF DESCRIPTION OF THE DRAWINGS

FIG. 1 shows the translucent/diffusive surface 11 of a 3D-printed model 10 with satellite imagery displayed onto the model 10.

FIG. 2 shows a positive model 10 of a 1.0 km×0.56 km region of Cambridge, Massachusetts, United States, generated by three-dimensional laser detection and ranging (LADAR) data displayed in EYEGLASS software, and viewed from a 40° tilt from overhead.

FIG. 3 shows the model 10 of FIG. 2 viewed from directly overhead with colors representing height.

FIG. 4 shows the translucent/diffusive surface 11 of a positive reproduction 12 formed of printed plastic tiles 13 affixed on a foundational Plexiglas sheet with a thin layer of epoxy in the seams between the tiles 13.

FIG. 5 shows a negative mold 14 of the city, formed of flexible rubber silicone cast onto the 3D printed part.

FIG. 6 shows a close-up of the silicone negative mold 14, which allows the capture of fine details of the city.

FIG. 7 shows a hard transparent positive model 10 of the city cast in a transparent urethane plastic negative mold 14 with a 2-foot ruler for scale.

FIG. 8 shows a positive city model 10 after painting and after being mounted in a display enclosure 16.

FIG. 9 shows a MATLAB simulation of a projection 17 onto a base surface 24 of a positive model 10 from a projector 18 and mirror 20 mounted inside the enclosure 16.

FIG. 10 shows a physical mounting of the projector 18 and mirrors 20 inside the display enclosure 16. In the left side of the display enclosure 16 is a laptop computer 22 that drives the projector 18.

In the accompanying drawings, like reference characters refer to the same or similar parts throughout the different views. The drawings are not necessarily to scale; instead, emphasis is placed upon illustrating particular principles in the exemplifications discussed below.

### DETAILED DESCRIPTION OF EMBODIMENTS

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially, though not perfectly pure, as practical and imperfect realities may apply; e.g., the potential presence of at least trace impurities (e.g., at less than 1 or 2%) can be understood as being within the scope of the description; likewise, if a particular shape is referenced, the shape is intended to include imperfect variations from ideal shapes, e.g., due to manufacturing tolerances.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

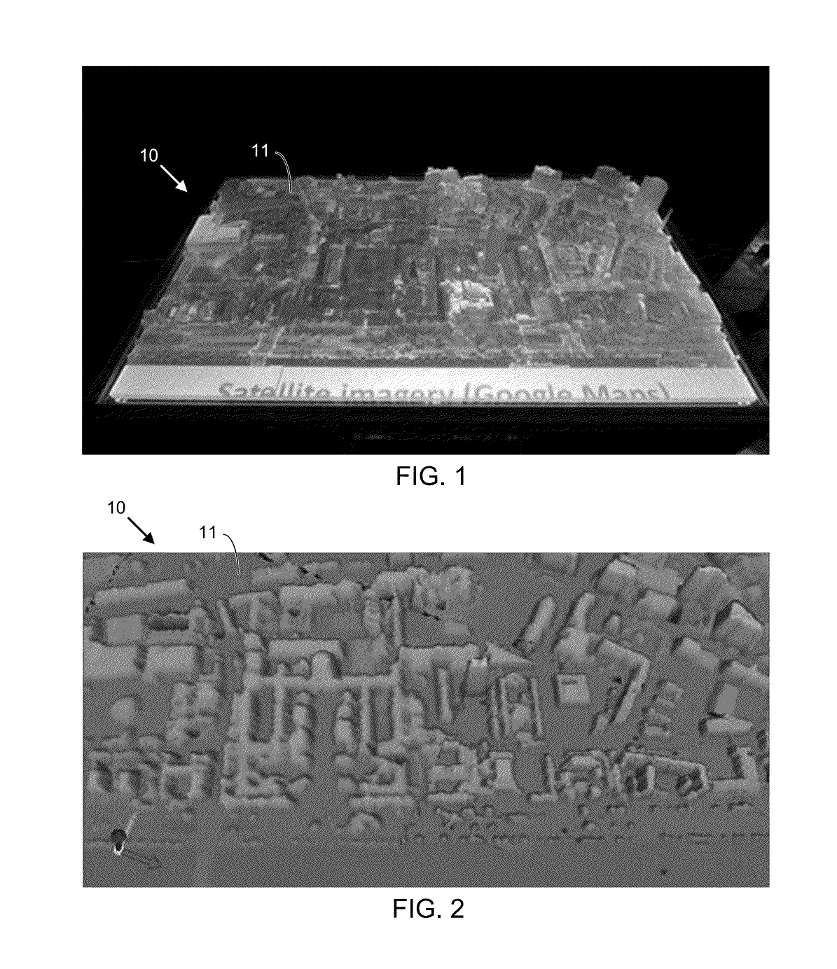

The following description is directed to an embodiment in which a monolithic miniature city model 10, as shown in FIG. 1, is 3D printed from a high-resolution laser detection and ranging (LADAR) dataset for an actual city or a portion of a city serving as the source surface. As used herein, the term “city” represents the structures in any city, town, village, or other collection of structures for habitation built by humans. Instead of fashioning each building individually, we can reproduce the entire city model, including ground topography, en masse.

3D printing is a process for making a three-dimensional object of almost any shape from a 3D model or other electronic data source primarily through additive processes in which successive layers of material are laid down under computer control. Any of a variety of 3D printing processes can be used in this method. For example, in the 3D-printing process of stereolithography (see U.S. Pat. No. 4,575,330), an ultraviolet laser can be used to cure layers of photopolymer to form the desired shape layer by layer. in another process, known as fusion deposition, modeling liquid plastic or metal is pushed through a nozzle to create a desired shape layer as the by layer, as the liquid plastic or metal hardens with cooling (see U.S. Pat. Nos. 5,204,055 and 5,121,329). In still another process, developed at Massachusetts Institute of Technology, layers are deposited by depositing drops of liquid binder on successively spread layers of powder, with the un-binded powder being removed to form the desired shape.

Owing to optical limitations in printable materials (for our particular 3D printer), the printed plastic part was utilized as a positive reproduction 12 to create a negative mold 14 from which we recast the city model 10 into optical-grade transparent plastic. The model 10 can be partially transparent, as the model 10 need not be perfectly transparent to serve its purpose—as long as it allows light to pass through and exit its opposite surface. To achieve the desired wide viewing angle, the transparent cityscape was subsequently coated with a thin layer of diffusing paint (e.g., Screen Goo from Goo Systems Global with distribution in Henderson, Nevada, USA), rendering the part translucent. In other embodiments, the translucent surface 11 on the model 10 can be obtained by treating the surface (e.g., by sanding or chemically etching it) to increase the model's surface roughness and thereby increase the opacity of the model surface.

A projector 18 and mirrors 20 were then used to display maps and analysis (in the form of a light image with distinct spatial and temporal features across the projected image) upon the model 10 from below the model 10. The final result, entitled LuminoCity, is a novel approach to the display of 3D datasets. In the following sections, we first describe how the LADAR data was used to generate the 3D printed part. Then we describe the molding process and finally detail the steps for completing the display.

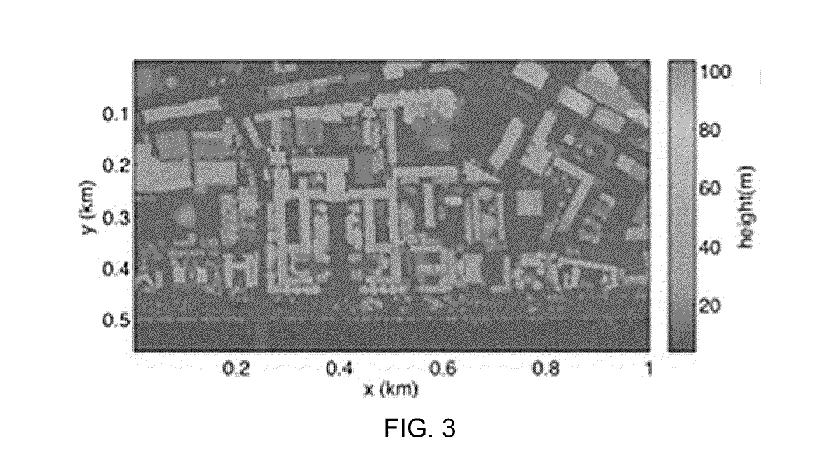

The LADAR dataset for this work was acquired over Cambridge, Mass., in 2005, with a resolution of ˜1 m. Although later LADAR datasets were of higher resolution and contained less noise, these datasets required remediation. We applied various filters and denoising processes to the data using MATLAB software (from The Mathworks, Inc., Natick, Mass., USA) to transform it into a volume suitable for 3D printing. MESHLAB open-source software (available at http://meshlab.sourceforge.net/) was then used to perform additional surface processing. Note that, since the LADAR data is acquired from an aerial platform, the data contains only the z-profile of the buildings but lacks any details of the building facades. A 1.0 km×0.56 km region of Cambridge, Mass., United States, generated by three-dimensional laser detection and ranging (LADAR) data. displayed in EYEGLASS software and viewed from a 40° tilt from overhead is shown in FIG. 2. Meanwhile, FIG. 3 shows a direct overhead view of the same region with illuminated colors representing height, as shown in MATLAB.

The LADAR dataset was provided as a regularly gridded data set such that the value of each point represented the height, z(x,y). We first converted the LADAR dataset into a triangulated stereolithography (STL) file. The following steps were then performed for format conversion using MATLAB software.

First, the LADAR z-data was triangulated using a simple triangulation scheme, splitting each four-point grid region into two left-hand triangles. This triangulation generates only a surface; hence, we generated a flat bottom (base) surface 22 and sides to create a closed volume. We ordered the triangle vertices so that all normals face outwards and store the vertices in a MATLAB patch structure. MATLAB software then converts the patch to a stereolithography (STL) file.

The STL file was then uploaded to the 3D printer. The 3D printing software is set with the scale factor for the LADAR data (scaling can be performed using the MATLAB software or using the 3D printing software). A uniform scale factor (1:1,000) was used in x, y, and z dimensions to preserve physical realism. Choosing the scale factor involves consideration of some trade-offs. For this particular embodiment, using a lower scale factor (e.g., 1:2500) may render many topographic features, such as roads and trees, to appear practically flat, which may reduce the value of 3D printing the model. As the scale factor becomes higher (e.g., 1:500) in this particular embodiment, either the model area grows or the model 10 shows the architecture of fewer buildings, rather than a larger urban area. For this particular embodiment, we decided on a model linear size of ˜1 m corresponding to a physical linear size of ˜1 km in order to show a reasonably sized urban region, rather than show architectural features of a small number of buildings. With these considerations, the scale of 1:1,000 was considered to be reasonable for this example.

In other embodiments, the model 10 can be used as a rear projection of the surface of a cell or of height data from atomic force microscopy, where the model 10 may have dimensions that render features of the scanned object visible to the human eye, and where the model 10 may, therefore, be much larger than the source surface. In still other embodiments, the source can be much larger the scale of objects on earth; for example, the source can be features of the Milky Way Galaxy; and the rear-projection model 10 can be many, many orders of magnitude smaller than the galaxy, itself.

The scaled region was subdivided into tiles 13, each with a dimension of 19×20 cm, which approaches the printable bed size of the 3D printer that was used. The 3D city positive reproduction 12 was printed in acrylonitrile butadiene styrene (ABS) plastic, commonly used in 3D printers and notable for its toughness and light weight. Each tile 13 took 14-28 hours to print, with flat river regions printing considerably faster than regions containing tall buildings.

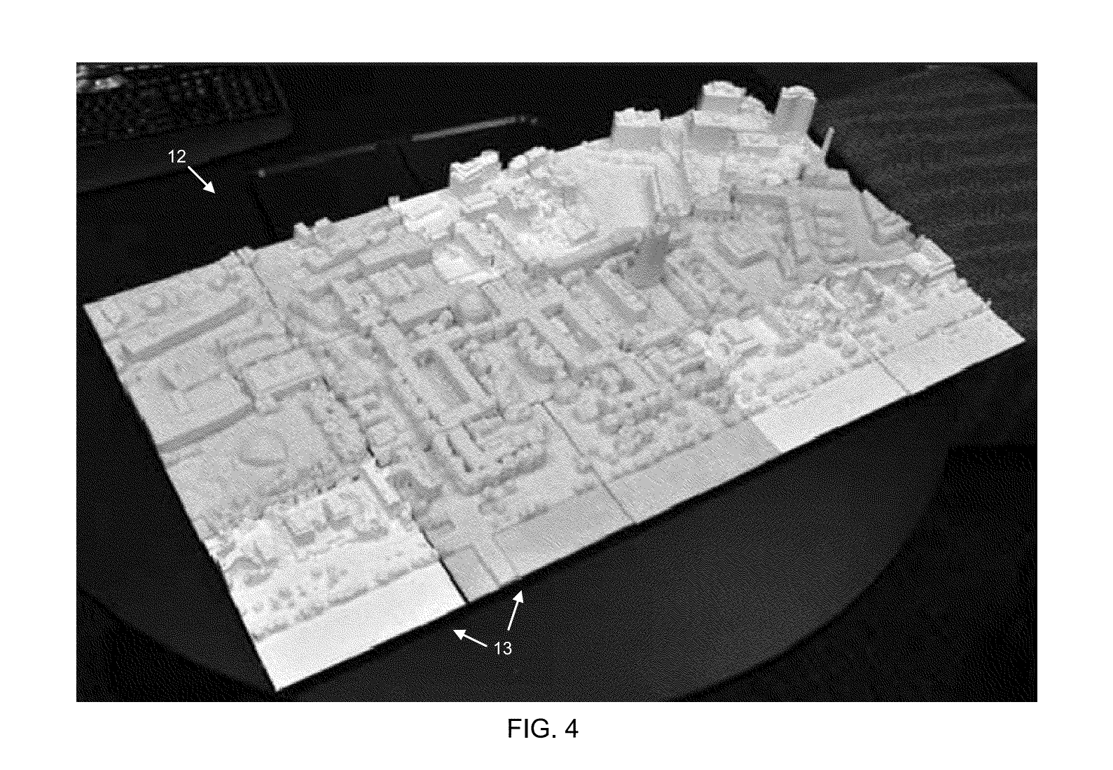

The completed reproduction 12 comprises fifteen tiles 13, with a total model size of 1 m×0.56 m, corresponding to a source physical size of 1 km×0.56 km. The aspect ratio was chosen to correspond to the 16:9 ratio of display systems. After all of the tiles 13 were printed, the tiles 13 were affixed onto a foundational plexiglas sheet, which served as a substrate, and a thin layer of epoxy was laid between the seams of the tiles 13. The tiles 13 (before application of epoxy) are shown in FIG. 4.

The printed 3D city reproduction 12 was then used as the positive representation to form a negative silicone mold 14. One large negative mold 14 formed of silicone was constructed from the smaller plastic tiles 13 (rather than forming a separate silicone mold 14 for each tile) in an effort to reduce any undesirable visible side-effects at the interface between tiles 13. A positive urethane model 10 was then cast from the negative silicone mold 14.

This molding process offered several advantages. First, molding is faster than repeatedly reprinting the entire city model with the 3D printer to produce multiple copies of the city models. Next, the molding process offered freedom in material choice. In this embodiment, the 3D printer only printed a colored acrylonitrile butadiene styrene (ABS) plastic. The molding process then generated a hard, optically transparent urethane plastic, which satisfied the transmissivity requirements for this particular embodiment of the display.

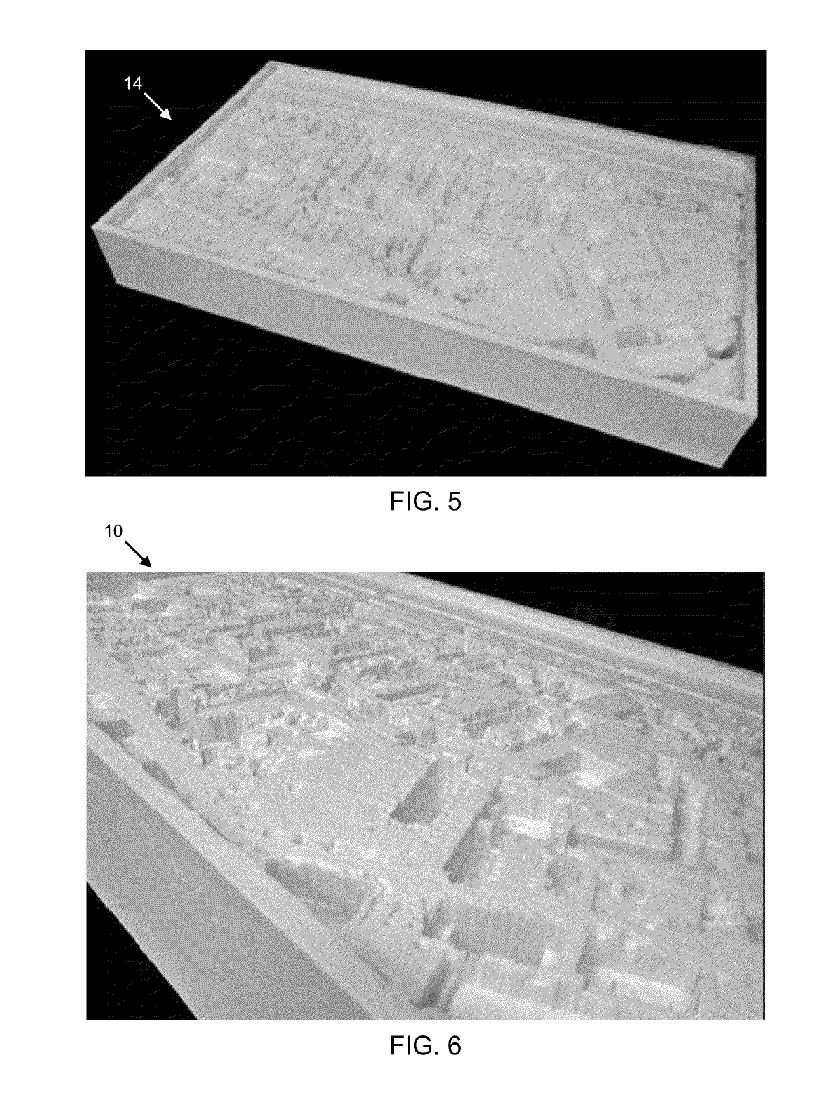

Following the standard molding process, molds 14 can be poured with one piece (i.e., the mold 14 or the cast part) being rigid and the complementary piece being flexible, which allows the flexible piece to be separated from the rigid piece by peeling the flexible piece off. From the printed rigid ABS pieces, a negative version 14 of the city model was formed in flexible rubber silicone, as shown in FIGS. 5 and 6, with the following dimensions: length=1 m, width=0.56 m, and height=0.14 m.

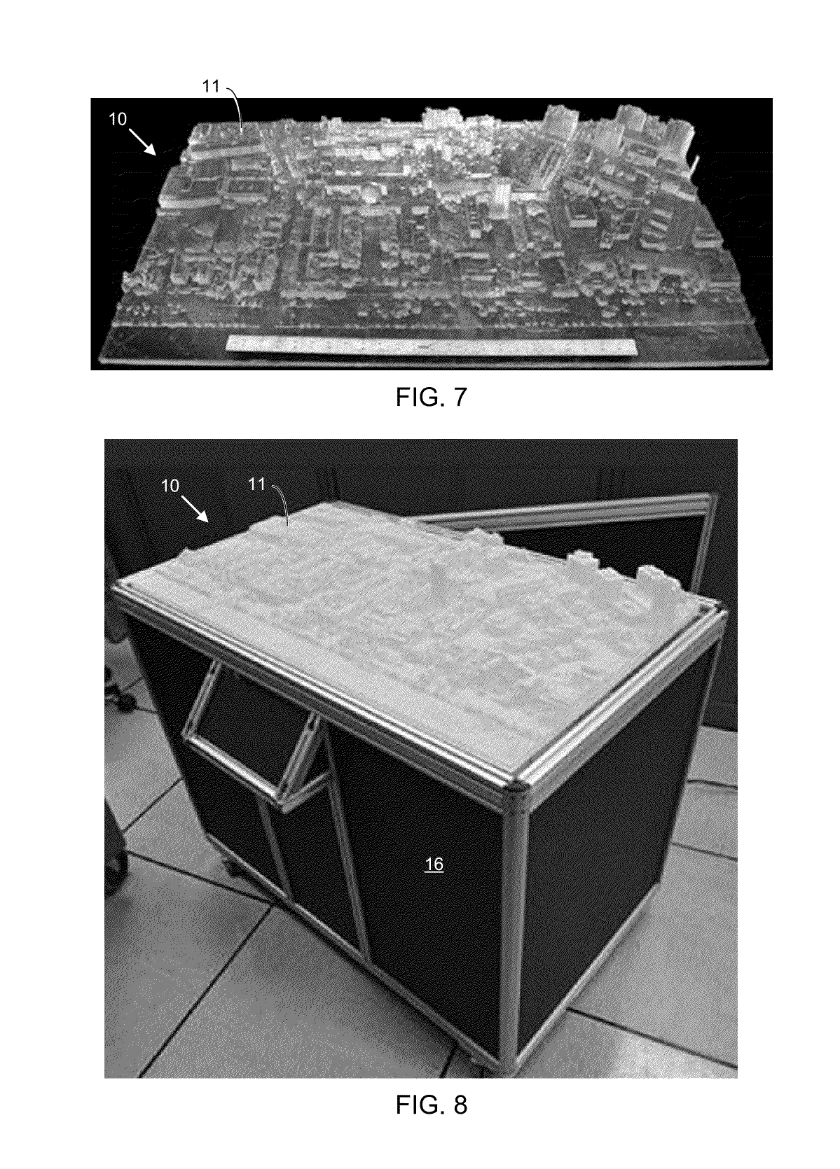

Next, the urethane molding material was poured into the silicone rubber, now serving as a mold 14. Casting the urethane into this negative silicone mold 14 forms the hard transparent positive version of the city model 10, as shown in FIG. 7. The transparent model 10 of the city was covered with a thin coat of rear-projection paint so that the model 10 could be illuminated from below. The model 10 was then mounted onto a display cabinet 16, as shown in FIG. 8, with a projector 18 mounted inside the enclosure 16 beneath the model 10. Although a short-throw projector was used here, the required projector-to-screen distance to illuminate the entire model 10 was (at least) 1 m; because the interior height of the display enclosure 16 was only 0.73 m, the beam path was folded inside the display enclosure 16 to provide a beam path longer than the height of the enclosure 16.

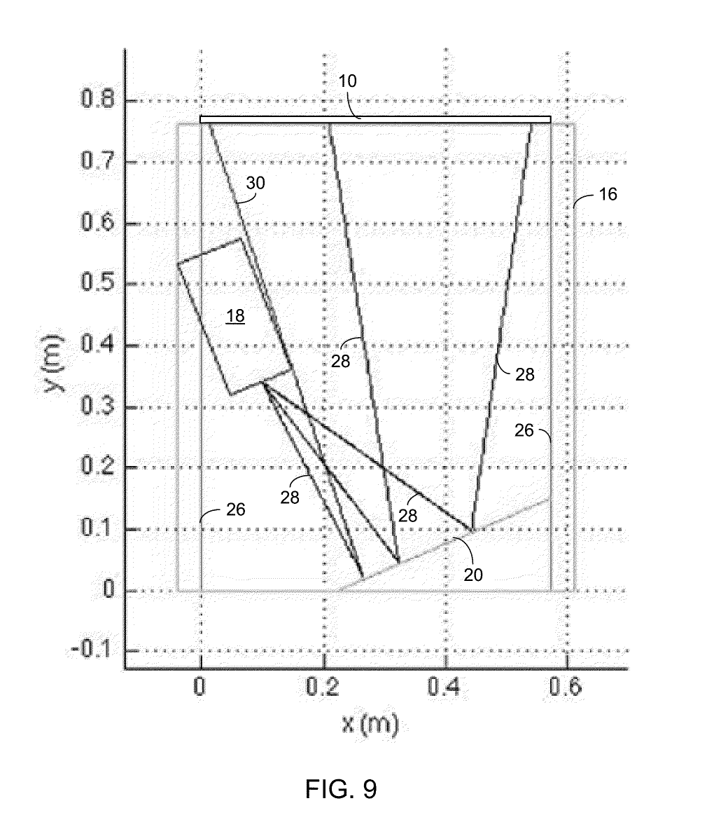

A simple ray-tracing simulation was developed using the MATLAB software that allowed the projector 18 to be positioned so that the projector 18 would fit inside the display enclosure 16, and the image would span the width 26 of the model 10 (the width of which is shown by the indicated lines). As shown in FIG. 9, there is barely enough room to fit the projector 18 inside this display enclosure 16, and the indicated ray on the left side indicates that the left-most beam edge 30 is slightly clipped by the projector 18 such that the projection 28 does not reach the entire base surface 24 of the model 10. The path length between the projector 18 and the display model 10 is 1.1 m.

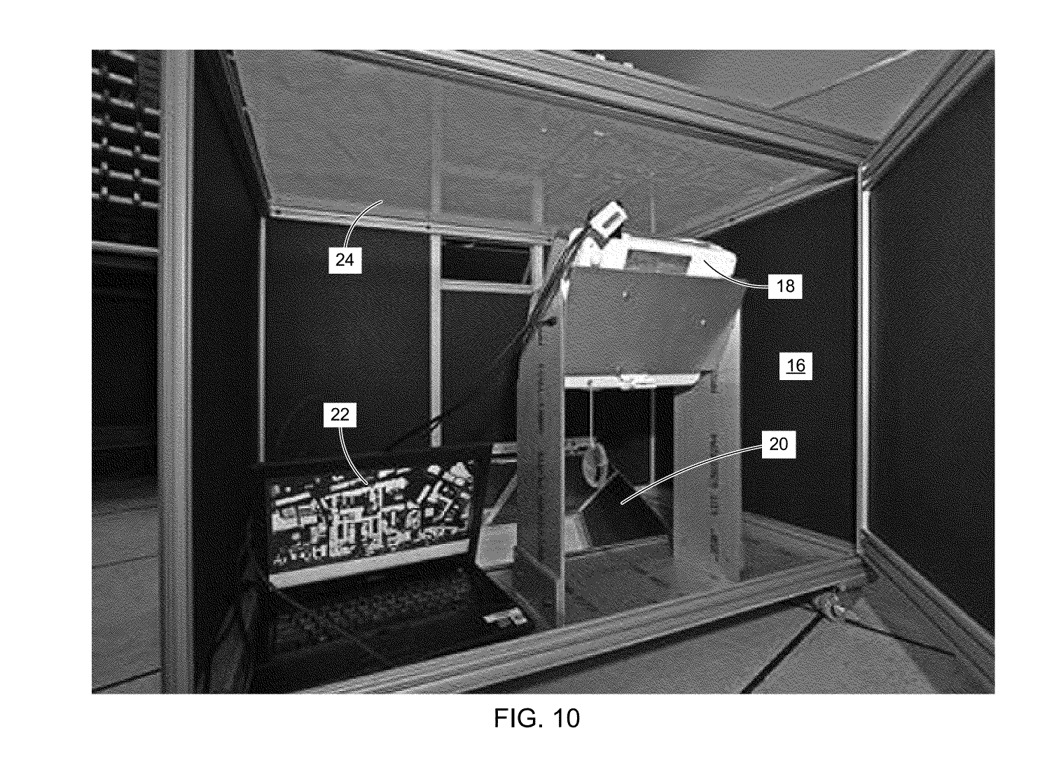

FIG. 10 shows the projector 18 and mirrors 20 physically mounted inside the display enclosure 16. To the left of the display enclosure 16 is a laptop computer 22 that drives the projector 18. The projector 18 is mounted at the steep inclination angle of 68°, and the mirror 20 is mounted at 22° (these angles are relative to horizontal). Mounting the mirror 20 at this angle does result in optical distortion, which can be corrected with the projector's built-in keystoning function. With this design, the projector 18 can be mounted inside the display enclosure 16 and can fully illuminate the city model 10 without occlusion.

In particular embodiments, the buildings can be illuminated with colors, assigned as a function of their height. FIG. 1 shows satellite imagery (e.g., vegetation, which can be shown with green light) displayed on the acrylic piece. Other visualizations currently available for LuminoCity include floodmaps, computer network traffic, air quality, live traffic, locations of social media (e.g., TWITTER) postings, and highlighted buildings, among others.

The above-described exemplifications focused on a city model, these techniques can likewise be performed to generate 3D models of a variety of other landscapes and structures.

In additional embodiments, the initial dataset for the city or other surface to be modeled can be derived from camera images or from other types of scanning that will enable recognition of surface contours and other dimensions and spacing in place of or in addition to using LADAR data.

In other embodiments, the initial data set for the model 10 may be generated by a computer 22 without using LADAR [e.g., the initial dataset can represent an imagined virtual city, landscape, or other object(s) with topographical features without first scanning real objects].

In additional embodiments, other additive or reductive 3D fabrication techniques, such as photolithography, laser cutting/etching, etc., may be used to form the initial reproduction 12 (or final model 10) from a digital dataset as a substitute for the 3D printing technique described herein.

In other embodiments, the positive reproduction 12 is printed using 3D printing techniques, as described above, and the negative casting to form a negative mold 14 and the subsequent casting to form a positive model 10 using the negative mold 14 may be omitted. I.e., the 3D-printed model is directly incorporated into the apparatus as the display model 10, though it can likewise be treated, e.g., by providing a translucent surface coating 11.

In various other embodiments, the projected images can be controlled by Microsoft KINECT sensor; control and information can be provided on a touchscreen attached to the display case 16; live streaming data (e.g., from a website) can be communicated via the projector 18; the positive display model 10 can be directly printed as a clear material (skipping the casting steps); optical fibers can be printed to allow for the illumination of sides of buildings, etc. (via projection of a transformed image); the positive display model 10 can be produced in multiple pieces instead of as one piece so that new buildings, etc., can easily and quickly be added/subtracted; the display of text, not just images, can also be projected on the model 10 (as shown in FIG. 1).

In still another embodiment, the model 10 can be in the form of a hollow sphere (or other enclosed shape) with multiple projection devices mounted inside the sphere to illuminate the sphere from within. This type of configuration can be used, for example, in a three-dimensional globe model 10 (modeling the earth's surface), where particular countries, regions, continents, weather patterns, sun exposure, ocean flows and sea levels, ice/snow cover, vegetation, etc., can be alternatively modeled. In another embodiment, the model 10 can have any of a variety of three-dimensional shapes. For example, the entire model 10 can represent a building, where projectors 18 are mounted inside the building model 10 with the model's outer surfaces 11 including features that replicate walls, windows, rooflines, etc., of the building. Any of a variety of images or videos can be projected onto the model surface, including images/videos of, e.g., sunlight, shade, rain, etc., or of an event, such as a fire in the building. In another example, the model 10 can be a representation of a living organism (e.g., a human), where, for example, projectors 18 mounted inside the organism model 10 can project images/videos of biological processes, such as blood flow, muscle activation, respiration, etc., onto model's outer surface 11. In other embodiments, the diffusive or translucent surface 11 can be an inside surface of a model 10 that forms a partial or full enclosure, wherein projectors 18 can be mounted outside the model 10 to illuminate its inner surface 11, and the viewer can be positioned inside the enclosure formed by the model 10.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety; and appropriate components, steps, and characterizations from these references may or may not be included in embodiments of this invention. Still further, the components and steps identified in the Background section are integral to this disclosure and can be used in conjunction with or substituted for components and steps described elsewhere in the disclosure within the scope of the invention. In method claims, where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A method for fabricating an illuminated three-dimensional model, the method comprising:
importing or generating a digital dataset representing a surface of a three-dimensional source;
producing a three-dimensional model of the three-dimensional source surface from the digital dataset, wherein the three-dimensional model has a translucent or diffusive surface and a base surface; and
mounting a projection device in a configuration such that distinctive patterns of light are directed from the projection device through the base surface of the three-dimensional model to selectively illuminate at least a portion of the translucent or diffusive surface of the three-dimensional model.

2. The method of claim 1, wherein the three-dimensional model is produced by 3D printing.

3. The method of claim 2, wherein the three-dimensional model is printed as a plurality of tiles, the method further comprising joining the plurality of tiles after printing.

4. The method of claim 1, wherein the three-dimensional model is a positive model formed by a method comprising:
fabricating a positive reproduction of the three-dimensional source surface by 3D printing;
casting another material onto the 3D-printed positive reproduction to form a negative mold;
casting the positive three-dimensional model into the negative mold; and
removing the negative mold.

5. The method of claim 4, wherein the 3D-printed positive reproduction is printed as a plurality of tiles, the method further comprising joining the plurality of tiles after printing, and wherein the negative mold is cast on the joined tiles.

6. The method of claim 4, wherein the 3D-printed positive reproduction comprises acrylonitrile butadiene styrene, wherein the negative mold comprises silicone, and wherein the cast positive three-dimensional model comprises a urethane polymer.

7. The method of claim 1, wherein the three-dimensional model is a positive model formed by a method comprising:
fabricating a negative reproduction of the three-dimensional source surface by 3D printing;
casting another composition into the 3D-printed negative reproduction to form a positive model; and
removing the positive model from the 3D-printed negative reproduction.

8. The method of claim 1, wherein the source surface includes surfaces from at least a portion of a city.

9. The method of claim 1, wherein the three-dimensional model is substantially transparent under the translucent or diffusive surface.

10. The method of claim 9, further comprising forming the translucent or diffusive surface of the three-dimensional model is produced by coating the three-dimensional model with a translucent paint.

11. An illuminable three-dimensional model apparatus, comprising:
a display enclosure;
a three-dimensional model of a three-dimensional source surface, wherein the three-dimensional model is mounted on the display enclosure, wherein the three-dimensional model has a translucent or diffusive surface facing away from the display enclosure and a base surface facing into the display enclosure; and
a digital projector mounted in the display enclosure and configured to direct light images through the base surface of the three-dimensional model and selectively illuminate portions of the translucent or diffusive surface of the three-dimensional model.

12. The illuminable three-dimensional model apparatus of claim 11, further comprising at least one optical component mounted in the display enclosure and configured to direct light images from the digital projector onto the base surface of the three-dimensional model.

13. The illuminable three-dimensional model apparatus of claim 11, further comprising a computing device in communication with the digital projector.

14. A method for selective illumination of a three-dimensional model, the method comprising:
utilizing an illuminable three-dimensional model apparatus, comprising a three-dimensional model of a three-dimensional construct, wherein the three-dimensional model includes a translucent or diffusive surface and a base surface; and a projector configured to project an image onto and through the base surface; and
directing a light image with distinct spatial features from the projector through the three-dimensional model to distinctly illuminate different portions of the translucent or diffusive surface.

15. The method of claim 14, wherein the light image is directed from the projector onto an optical component that reflects the light image onto the three-dimensional model.

16. The method of claim 14, wherein the three-dimensional model comprises a model of at least a portion of a city.

17. The method of claim 16, wherein the light image selectively illuminates individual buildings in the city.

18. The method of claim 16, wherein the light image comprises a representation of a satellite image.

19. The method of claim 14, further comprising changing the composition of the light image over time to provide dynamic illumination of the three-dimensional model.

20. The method of claim 14, further comprising illuminating at least a portion of a sidewall of the three-dimensional model.
